(19) United States
(12) Patent Application Publication
(10) Pub. No.: US 2005/0204922 A1
(43) Pub. Date: Sep. 22, 2005

(54) Air cleaner and expandable frame therefor

(76) Inventors: Guolian Wu, St. Joseph, MI (US); Andrew D. Litch, St. Joseph, MI (US); Paul B. Allard, Stevensville, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/801,325

(22) Filed: Mar. 16, 2004

(51) Int. Cl. B03C 3/30

(52) U.S. Cl. 96/66; 55/496

(57) ABSTRACT

The invention relates to an air cleaner and an expandable frame for use with a conventional household air conditioning system with a return duct having an opening sized to receive a standard panel filter. The expandable air cleaner frame comprises a peripheral frame sized to be received within the opening in the return duct and a carrier coupled to the peripheral frame. The carrier supports an air conditioning element, such as a field charger or an electrostatic precipitator. The expandable air cleaner frame is movable between a collapsed position, wherein the effective thickness thereof is less than the opening, and an expanded position, wherein the effective thickness thereof is greater than the opening.

### BACKGROUND OF THE INVENTION

1. Field of the Invention

The invention relates to an air cleaner for air conditioning system, such as a furnace or a central air conditioner, and, more particularly, to an air cleaner that is expandable within an air duct of an air conditioning system. In another aspect, the invention relates to an expandable air cleaner frame for loading multiple filter elements into an air duct.

2. Description of the Related Art

Conventional forced air household furnaces or central air conditioners (generically referred to as air conditioning systems) comprise a return duct to direct air into a central unit for conditioning the air by either heating or cooling the air and an outlet duct for distribution of the conditioned air from the central unit throughout the home. The return duct typically has a filter disposed therein for removing dust and other particulate matter from the incoming air. As air passes through the filter, the matter is removed to prevent distribution through the home and to avoid contamination of the central unit.

Several types of filters exist for removal of matter from the air. The most common variety is a standard, rectangular panel replaceable filter, which is composed of a random arrangement of fibers, such as fiberglass. Panel filters are usually approximately one inch thick and are inserted into a similarly sized opening in the duct. They filter the air by trapping particles within the randomly oriented fibers. Although these filters are used in about 85% of American homes and are able to capture large particles, they do little to remove smaller contaminants from the air. Rather, standard panel filters mainly protect the central unit and minimize the amount of dust on the heating or cooling equipment. Once these filters become saturated with dirt, dust, and the like, they are meant to be removed from the duct and thrown away and replaced with a new filter. Alternatives to the replaceable panel filter include replaceable and reusable pleated filters, high efficiency pleated filters, high efficiency particulate air (HEPA) filters, and washable fiberglass filters. As their name indicates, pleated filters are filters that are pleated or folded to provide a large surface area for collecting particles. Although pleated filters are more efficient than panel filters, they must be replaced more frequently to avoid airflow restriction. High efficiency pleated filters are reusable and are electrostatically charged to capture small particulate matter less than one micron in diameter. Such small particles comprise approximately 98-99% of the particles of indoor air by count or number and are most strongly related to observed health impact. HEPA filters comprise a core fiber that is folded back and forth over corrugated separators. The fiber is composed of very fine sub-micron glass fibers in matrix of larger fibers. Although these filters are efficient at removing submicron particles, they are expensive and are typically not designed to fit in standard forced air systems. Furthermore, HEPA filters create a high pressure drop, which is highly undesirable in a home heating or cooling system. Finally, washable fiberglass filters can be reused, but they cannot be completely cleaned to their original state and, therefore, can restrict airflow. Such filters also suffer from relatively low filtration efficiency compared to HEPA filters.

Duct mounted electronic air cleaners, which typically use electrostatic precipitation systems, use an electrostatic or ionic field to trap charged particles. Such systems are extremely efficient, especially in the 0.1 to 10 micron size range, and create a very low pressure drop. Because trapped particles on collecting plates can build up and reduce the electrostatic field and, hence, collection efficiency, the cleaners should be cleaned weekly or monthly. Electrostatic precipitators can emit small amounts of ozone, which can be reduced with the addition of a carbon post filter or by using positive ionization instead of negative. While electronic air cleaners are more effective than the above-described fiber-based filters (with the exception of HEPA filters), they are relatively very expensive by comparison. Currently, they also are designed as a separate special unit that is installed between the central unit and the return duct, and have a width typically between 4-6 inches. The special unit cannot be fit within the standard filter opening found in most return ducts. The special units also require relatively complicated installation typically performed by a professional.

Electronic air cleaners are sometimes known to include conventional fiber-based filters instead of energized collecting plates along with its typical ionizer or field charger section. The filter may also in some instances be actively charged or energized to improve collection efficiency. This combination is called a hybrid filter. These hybrid filters can have a slightly increased air pressure drop compared to an electronic air cleaner with collecting plates due to decreased free flow area, but they have better particulate loading properties due to increased surface area.

The need for professional installation of electronic air cleaners, including hybrid filters, and other air cleaner assemblies and their much higher cost weighs heavily against retrofitting current heating or cooling systems with these types of systems.

### SUMMARY OF THE INVENTION

The invention provides the better filtering characteristics of the hybrid and/or electronic air cleaner in a configuration that can be inserted into the standard filter opening common to many heating and/or cooling forced air systems. An air cleaner according to the invention is for use in an air conditioning system comprising an air duct defining an airflow passage, with the air duct defining an airflow path and having a standard filter opening of a predetermined size in which a standard filter can be inserted into the airflow passage to filter the air passing through the air duct. The air cleaner comprises a collector, an air conditioning element, and an expandable air cleaner frame carrying both the collector and the air conditioning element to form an air cleaner assembly having an effective thickness. The expandable air cleaner frame is operable between a collapsed condition, wherein the effective thickness of the air cleaner assembly is such that the air cleaner assembly can be received within the standard filter opening, and an expanded condition, wherein the effective thickness of the air cleaner assembly is greater than the standard filter opening.

When the expandable air cleaner frame is moved from the collapsed to the expanded condition, at least one of the collector and the air conditioning element is extended into the airflow passage along the airflow path to thereby increase the effective thickness of the air cleaner assembly. The effective thickness of the air cleaner assembly can be less than 1 inch when in the collapsed condition.

The collector comprises a layer of random fibers that can be charged. Further, the collector is a low flow reducing filter.

The air conditioning element is a charged particle air cleaner, such as an ionizer or an electrostatic precipitator. The air conditioning element comprises an ionizing plate for generating ions to create ionized particles in the air stream, and the collector comprises one or more charged plates for attracting the ionized particles. The air conditioning element further comprises a ground plate for directing the flow of ions from the ionizing plate. Alternatively, the air conditioning element can be a HEPA filter.

The expandable air cleaner frame comprises an expansion mechanism for moving the expandable air cleaner frame between the collapsed and expanded conditions. The expansion mechanism is operable externally of the duct when the air cleaner is inserted into the duct to permit the movement of the expandable air cleaner frame from the collapsed to the expanded condition after the air cleaner is inserted within the duct. The expansion mechanism displaces at least one of the collector and the air conditioning element along the airflow path to thereby change the effective thickness of the air cleaner assembly.

The expandable air cleaner frame further comprises a peripheral frame and a carrier, with one of the collector and air conditioning element mounted to the peripheral frame and the other of the collector and air conditioning element carried by the carrier. The expansion mechanism connects the carrier to the peripheral frame such that the expansion mechanism moves the carrier relative to the peripheral frame to move the expandable air cleaner frame between the collapsed and expanded conditions. The carrier can be integrally formed with the other of the collector and air conditioning element.

The expansion mechanism comprises at least one series of mechanical linkages for moving the expandable air cleaner frame between the collapsed and expanded conditions. The at least one series of mechanical linkages is coupled with the peripheral frame and with the carrier so that displacement of the series of mechanical linkages moves the carrier relative to the expandable air cleaner frame. The expansion mechanism further comprises an actuating arm for displacing the series of mechanical linkages and a guide rail for directing the displacement of the series of mechanical linkages and the actuating arm.

The expandable air cleaner frame comprises a peripheral frame with a recess sized to receive a standard filter.

An expandable air cleaner frame according to the invention is for use in an air conditioning system having a duct with an opening having a predetermined size and defining an airflow path. The expandable air cleaner frame comprises a peripheral frame sized to be slidably received within the opening in the duct and a carrier for carrying a filter element. The peripheral frame forms a filter element recess sized to receive a filter element. The carrier is moveably mounted to the peripheral frame for movement between a collapsed condition, where the collective thickness of the peripheral frame and the carrier is such that they can be received within the opening in the duct, and an expanded condition, wherein the collective thickness of the peripheral frame and the carrier is greater than the opening in the duct. The expandable air cleaner frame can be inserted into the duct opening in the collapsed condition and then moved to the expanded condition to permit multiple filter elements to be inserted into the duct through the duct opening. At least a portion of the carrier is received within the filter element recess when the expandable air cleaner frame is in the collapsed condition. During movement of the carrier from the collapsed to the expanded condition, the carrier moves into the duct in a direction along the airflow path through the duct. The peripheral frame comprises an aperture through which a filter element can be slidably inserted into the peripheral frame.

The expandable air cleaner frame further comprises an expansion mechanism for moving the carrier between the collapsed and expanded conditions. The expansion mechanism is operable externally of the duct when the expandable air cleaner frame is inserted into the duct to permit the movement of the expandable air cleaner frame from the collapsed to the expanded condition after the expandable air cleaner frame is inserted within the duct. The expansion mechanism moves the carrier relative to the peripheral frame to thereby change the collective thickness of the peripheral frame and the carrier.

The expansion mechanism comprises at least one series of mechanical linkages for moving the expandable air cleaner frame between the collapsed and expanded conditions. The at least one series of mechanical linkages is coupled with the peripheral frame and with the carrier so that displacement of the series of mechanical linkages moves the carrier relative to the peripheral frame. The expansion mechanism further comprises an actuating arm for displacing the series of mechanical linkages and a guide rail for directing the displacement of the series of mechanical linkages and the actuating arm.

An air conditioning system according to the invention comprises an air duct, an airflow passage through the air duct, and a standard filter opening of a predetermined size in the air duct and in which a standard filter can be inserted into the airflow passage to filter the air passing through the air duct; and an air cleaner. The air cleaner comprises a collector, an air conditioning element, and an expandable air cleaner frame carrying both the collector and the air conditioning element to form an air cleaner assembly having an effective thickness. The expandable frame is operable between a collapsed condition, wherein the effective thickness of the air cleaner assembly is such that the air cleaner assembly can be received within the standard filter opening, and an expanded condition, wherein the effective thickness of the air cleaner assembly is greater than the standard filter opening.

When the expandable air cleaner frame is moved from the collapsed to the expanded condition, at least one of the collector and the air conditioning element is extended into the airflow passage along the airflow path to thereby increase the effective thickness of the air cleaner assembly. The effective thickness of the air cleaner assembly can be less than 1 inch when in the collapsed condition.

The collector comprises a layer of random fibers that can be charged. Further, the collector is a low flow reducing filter.

The air conditioning element is a charged particle air cleaner, such as an ionizer or an electrostatic precipitator. The air conditioning element comprises an ionizing plate for generating ions to create ionized particles in the air stream, and the collector comprises one or more charged plates for attracting the ionized particles. The air conditioning element further comprises a ground plate for directing the flow of ions from the ionizing plate. Alternatively, the air conditioning element can be a HEPA filter.

The expandable air cleaner frame comprises an expansion mechanism for moving the expandable air cleaner frame between the collapsed and expanded conditions. The expansion mechanism is operable externally of the duct when the air cleaner is inserted into the duct to permit the movement of the expandable air cleaner frame from the collapsed to the expanded condition after the air cleaner is inserted within the duct. The expansion mechanism displaces at least one of the collector and the air conditioning element along the airflow path to thereby change the effective thickness of the air cleaner assembly.

The expandable air cleaner frame further comprises a peripheral frame and a carrier, with one of the collector and air conditioning element mounted to the peripheral frame and the other of the collector and air conditioning element carried by the carrier. The expansion mechanism connects the carrier to the peripheral frame such that the expansion mechanism moves the carrier relative to the peripheral frame to move the expandable air cleaner frame between the collapsed and expanded conditions. The carrier can be integrally formed with the other of the collector and air conditioning element.

The expansion mechanism comprises at least one series of mechanical linkages for moving the expandable air cleaner frame between the collapsed and expanded conditions. The at least one series of mechanical linkages is coupled with the peripheral frame and with the carrier so that displacement of the series of mechanical linkages moves the carrier relative to the expandable air cleaner frame. The expansion mechanism further comprises an actuating arm for displacing the series of mechanical linkages and a guide rail for directing the displacement of the series of mechanical linkages and the actuating arm.

The expandable air cleaner frame comprises a peripheral frame with a recess sized to receive a standard filter.

### BRIEF DESCRIPTION OF THE DRAWINGS

In the drawings:

FIG. 1 is a perspective view of an air conditioning system in the form of a household furnace having a return duct defining an airflow passageway and having an opening sized to receive a standard filter;

FIG. 2 is an exploded view of an air cleaner according to the invention and comprising a collector, an air conditioning element, and an expandable air cleaner frame including a peripheral frame and an expansion mechanism;

FIG. 3 is a perspective view of the expandable air cleaner frame and air conditioning element in FIG. 2, wherein the expandable air cleaner frame is in an expanded condition;

FIG. 4 is a perspective view of the expandable air cleaner frame and air conditioning element in FIG. 2, wherein the expandable air cleaner frame is in a collapsed condition;

FIG. 5 is perspective view of the expansion mechanism from FIG. 2 in the expanded condition;

FIG. 6 is a perspective view of the expansion mechanism from FIG. 2 in the collapsed condition;

FIG. 7 is a perspective view of the expandable air cleaner frame and air conditioning element in FIG. 3 and the return duct in FIG. 1, wherein the expandable air cleaner frame is in the collapsed condition and positioned near the opening of the return duct;

FIG. 8 is a perspective view of the expandable air cleaner frame and air conditioning element and return duct from FIG. 7, wherein the expandable air cleaner frame is partially inserted into the return duct through the opening;

FIG. 9 is a perspective view of the expandable air cleaner frame and air conditioning element and return duct from FIG. 8, wherein the expandable air cleaner frame is completely disposed in the return duct;

FIG. 10 is a perspective view of the expandable air cleaner frame and air conditioning element and return duct from FIG. 9, wherein the expandable air cleaner frame has been moved to the expanded condition to displace the air conditioning element within the return duct;

FIG. 11 is a perspective view of the expandable air cleaner frame and air conditioning element and return duct from FIG. 10, wherein the collector is partially inserted into the expandable air cleaner frame;

FIG. 12 is a perspective view of the expandable air cleaner frame and air conditioning element and return duct from FIG. 11, wherein the collector is completely disposed in the expandable air cleaner frame to form the air cleaner from FIG. 2, and showing an arrow to depict the direction of airflow within the return duct and through the air cleaner;

FIG. 13 is a perspective view of a second embodiment of an expandable air cleaner frame according to the invention comprising an auxiliary peripheral frame, wherein the expandable air cleaner frame is the expanded condition; and

FIG. 14 is a schematic view of a third embodiment of an expandable filter frame according to the invention comprising a filter loading mechanism for moving loaded collectors along the length of the return duct.

### DESCRIPTION OF THE INVENTION

The invention provides a cost-efficient air cleaner that permits usage of a multi-component filter system in a standard filter opening without professional installation. One implementation of the invention is an expandable air cleaning system having an expandable air cleaner frame that supports multiple filters and/or air conditioning elements and that can be inserted into a standard opening of a duct while in a collapsed condition and thereafter transformed to an expanded condition. The frame can be reverted to the collapsed condition for removal from the duct if any of the multiple filters and/or air conditioning elements require replacement or cleaning.

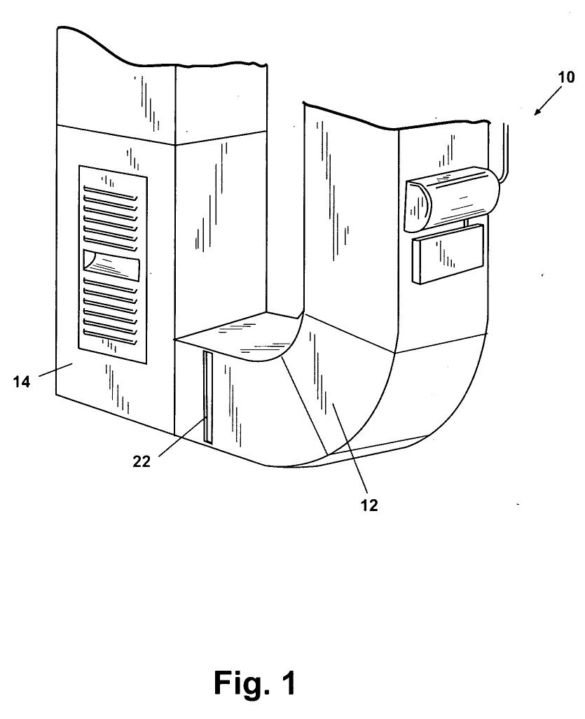

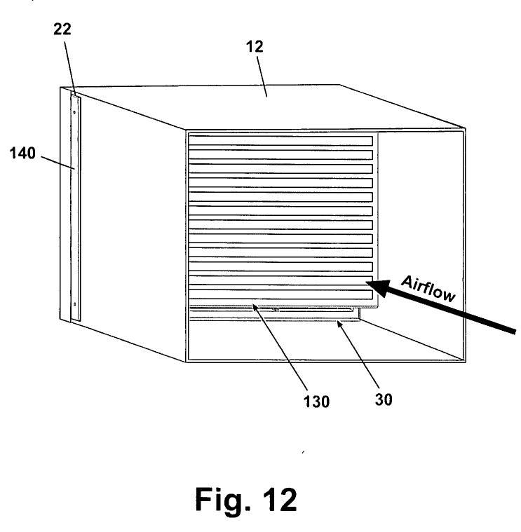

Referring now to the figures and to FIG. 1 in particular, a typical air conditioning system in the form of a household furnace 10 comprises a return duct 12 defining an interior airflow passageway (FIG. 12), a central unit 14, and outlet ducts (not shown) downstream from the central unit 14. A blower or fan (not shown) draws air from the return duct 12 and into the central unit 14, where the air is heated. The heated air is distributed from the central unit 14 throughout a house though the outlet ducts. The return duct 12 usually comprises a filter opening 22 having an industry standard predetermined size to receive a conventional, standard panel filter, which typically has a square or rectangular shape, depending on the size of return duct, and has an industry standard thickness of approximately one inch. When disposed inside the return duct 12, the conventional panel filter removes dust and other particulate matter from the airflow therethrough. Once the conventional panel filter becomes dirty, it is removed through the opening and discarded.

In homes with central air conditioning, the central unit 14 includes one or more evaporator coils to cool the air. When the air conditioning system is used, the air drawn into the central unit 14 is cooled by the evaporator coil(s) and then distributed throughout the house through the outlet ducts. As used in this description, the term central unit 14 applies to any air heating and/or cooling system using circulated air.

For purposes of this description, the term air condition system is used to generically reference any system that conditions the air. Such systems include tradition household forced-air furnaces and air conditioners. For simplicity, the description focuses on the use of the invention with in a furnace. However, the invention is applicable to any air conditioning system.

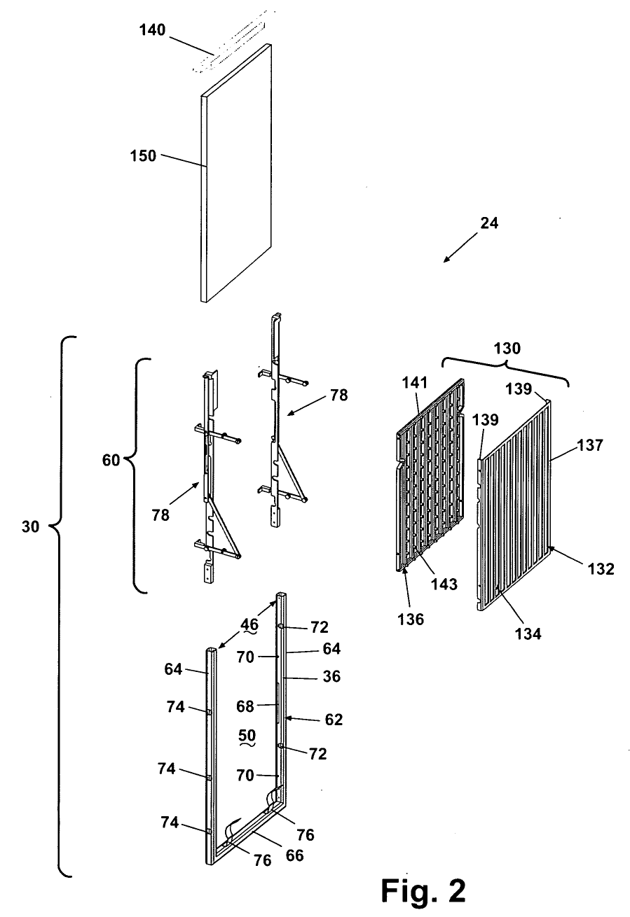

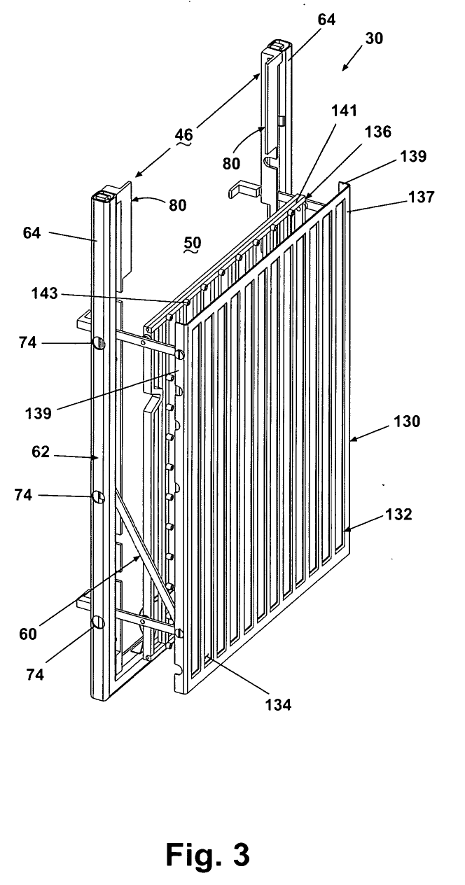

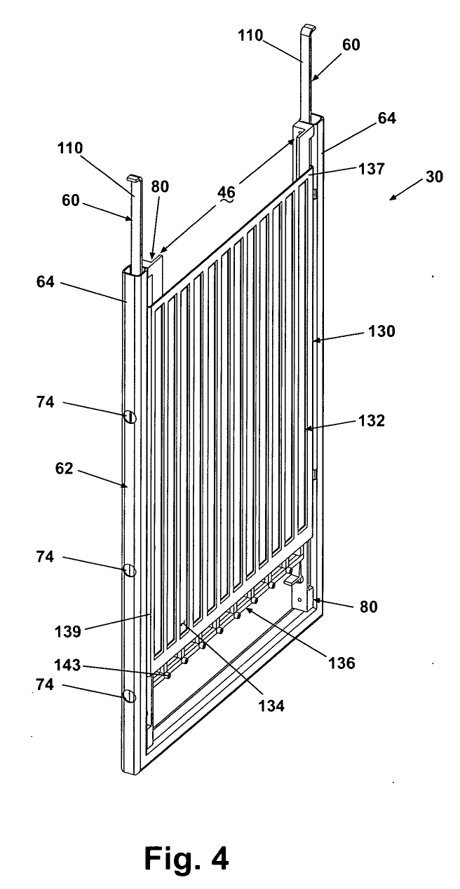

FIGS. 2-4 illustrate an air cleaner 24 according to the invention that can be inserted through the standard filter opening 22 in the return duct 12 of the furnace 10 or of a central air conditioning system, without the need for professional installation. The air cleaner 24 comprises an expandable air cleaner frame 30 that carries or supports an air conditioning element 130 and a collector 150. The expandable air cleaner frame 30 is operable between a collapsed position (FIG. 4), where it can be inserted into the filter opening 22, and an expanded condition (FIG. 3), where it carries the air conditioning element 130 within the duct 12.

In the present embodiment, the air conditioning element 130 is a field charger comprising an earth plane 132 and an ionization grid 136. The earth plane 132, located upstream of the ionization grid 136, has a planar base 137 with down-turned side edges 139, is preferably composed of a metallic material, and is preferably at an electrical potential of earth ground. A plurality of geometrically shaped cutouts 134 is formed in the planar base 137 of the earth plane 132. The ionization grid 136 comprises a peripheral frame 141 supporting electrically connected pins 143 or, alternatively, metal wires, that are at a high voltage to perform ionization of the air. The ionization grid 136 creates and releases ions that are drawn upstream to the grounded metallic earth plane 132. Dirt, dust, and other particulate matter within the air that flows through the cutouts 134 interact with the ions to form ionized particles that carry a charge. The cutouts 134 of the earth plane 132 condition the flow direction of the air and the particles constrained therein so as to increase the likelihood that the dust particles will be drawn to the ions to create ionized particles.

In the present embodiment, an air conditioning element carrier is integral with the air conditioning element 130. The planar base 137 and the edges 139 perform the carrier function for the earth plane 132. The peripheral frame 141 performs the carrier function for the ionization grid 136. The carrier function is the mounting of the air conditioning element 130 to the expansion mechanism 60 and the peripheral frame 62. For purposes of the invention, however, the air conditioning element carrier can be a separate component, such as a frame or crossbars, that supports the air conditioning element 130. Because the air conditioning element carrier and the air conditioning element 130 are integral in the present embodiment, reference to the air conditioning element 130 in the remainder of the description of this embodiment inherently refers to both the air conditioning element carrier and the air conditioning element 130.

The type of air conditioning element is not critical to the invention. Other types of air conditioning elements can also be used. Examples of other suitable air conditioning elements are a series of charged metal collection plates, as in an electrostatic precipitator. Alternatively, the air conditioning element can comprise a single element, such as a flow directing plane; an ionization grid; a charging plate, such as a charging grid; a standard panel filter; a pleated filter; an electrostatically charged pleated filter; a washable filter; an actively charged filter; an odor elimination module such as a carbon filter; an ultraviolet light module for eliminating bacteria, fungi, and viruses; an ultraviolet light or standard light with a titanium dioxide coated filter module for eliminating volatile organic compounds (VOCs); a humidification module; a dehumidification module; or combinations thereof. In short, the air conditioning element can comprise any type and number of structures or devices to alter, in any respect, the air that that flows therethrough.

The collector 150 collects the particles or other matter in the air. Preferably, the collector 150 is complementary to the air conditioning element 130 and is designed to collect the ionized particles created by the air conditioning element 130. However, the type of collector, like the air conditioning element, is not critical to the invention. Many suitable types of collectors can be used. The collector 150 can be any device for collecting dust or other particulate matter, including ionized particles, from the air. Examples of the collector are a panel filter; a pleated filter; an electrostatically charged pleated filter; a washable filter; an actively charged filter; a charged plate; an odor elimination module; an ultraviolet light module for eliminating bacteria, fungi, and viruses; an ultraviolet light or standard light with a titanium dioxide coated filter module for eliminating volatile organic compounds (VOCs); a humidification module; a dehumidification module; or combinations thereof suitable for use in a household furnace 10. Another example of the collector 150 is a charged device as disclosed in PCT Application Publication No. 00/61293. This device includes airflow passageways defined by plastic walls having areas of conductive material. High and low potentials are applied to these areas to attract charged or ionized particles as they flow through the passageways. Additionally, the collector 150 can comprise more than one collector, including multiples of the same collector or combinations of different types of collectors. Further, the collector 150 can be an air conditioning element similar to the air conditioning element 130. When the collector 150 is different from the air conditioning element 130, the combination of the collector 150 and the air conditioning element 130 forms a hybrid air cleaner. Both the collector 150 and the air conditioning element 130, regardless of type, can be generically referred to as filter elements.

The expandable air cleaner frame 30 permits the use of the air conditioning element 130 and/or collector 150 in a traditional filter opening 22, unlike prior air cleaning systems. The expandable air cleaner frame 30 comprises an expansion mechanism 60 and a peripheral frame 62. The peripheral frame 62 comprises spaced hollow bars 64 joined at one end by a cross bar 66 to form a U-shaped structure defining a recess 50 therein. An elongated aperture 46 separates the other ends of the hollow bars 64. A plurality of apertures, such as slot 68, holes 70, and notches 72, are disposed along the inside surface of the hollow bars 64, and three generally circular apertures 74 are positioned on the outside surface of the hollow bars 64. Additionally, optional spring tabs 76 positioned on the cross bar 66 extend towards the recess 50. When the collector 150 comprises more than one collector, the spring tabs 76 push the individual collectors in the direction of airflow to facilitate loading of subsequent collectors.

The expansion mechanism 60 couples the air conditioning element 130 to the peripheral frame 62. As the expandable air cleaner frame 30 is moved between the expanded and collapsed condition, the air conditioning element 130 is correspondingly moved between an expanded condition, wherein the air conditioning element 130 is spaced from the recess 50, as shown in FIG. 3, and a collapsed condition, wherein the air conditioning element 130 is displaced towards the recess 50, as shown in FIG. 4.

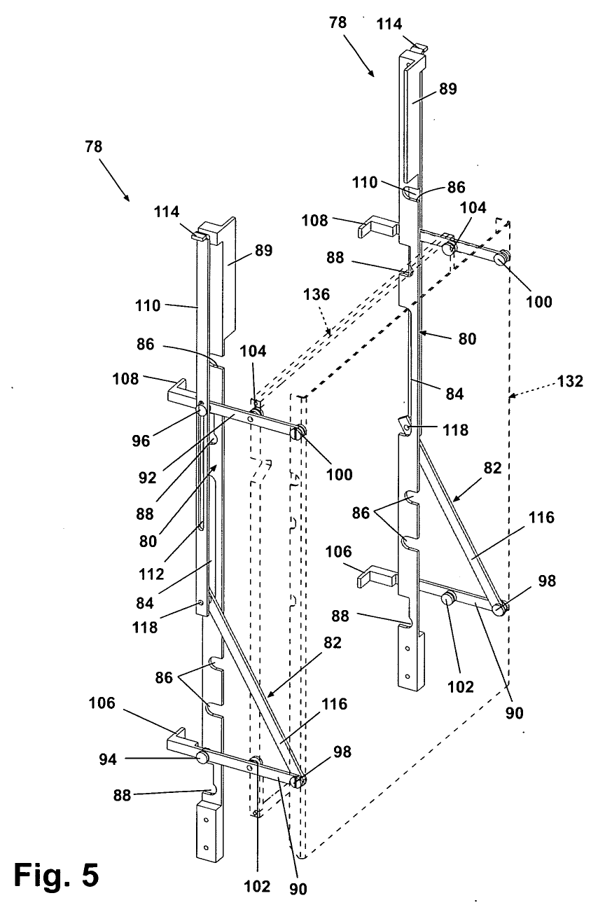

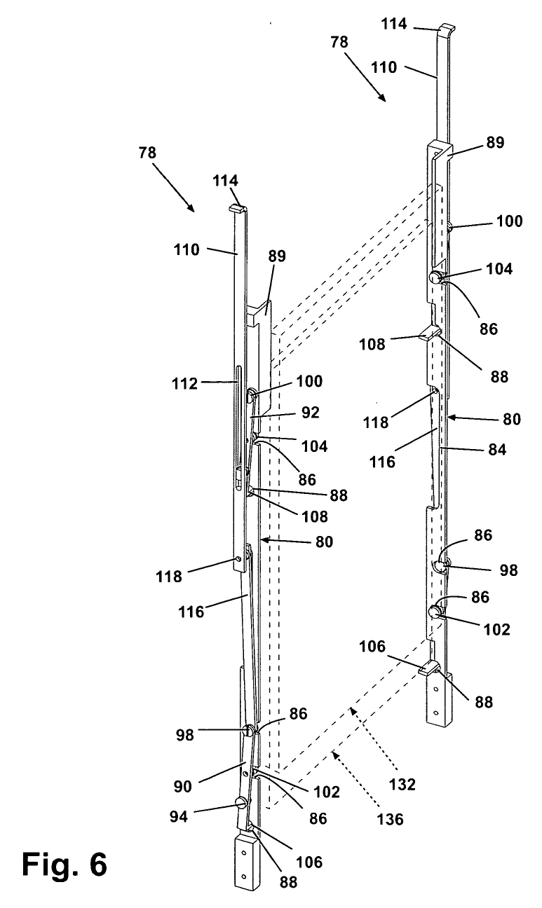

Referring to FIGS. 5 and 6 specifically and FIGS. 2-4 generally, the expansion mechanism 60 comprises two linkage assemblies 78 that are mirror images of each other and wherein one is disposed on each side of the peripheral frame 62 and the air conditioning element 130. For simplicity, only one of the linkage assemblies 78 will be described herein in detail, with it being understood the description applies to both.

The linkage assembly 78, which is best viewed in the expanded condition in FIG. 5, comprises a guide rail 80 and a series of mechanical linkages 82. The relative positioning of elements of the expansion mechanism 60 will be described herein with reference to the orientation of FIGS. 5 and 6. The guide rail 80 is an elongated member with an inwardly extending filter guide 89 at one end thereof and further comprises a central elongated groove 84, a plurality of notches 86, and a pair of indents 88.

The mechanical linkages 82 comprises parallel first and second mounting arms 90 and 92 that are each pivotally mounted near one end to the guide rail 80 with pivot pins 94 and 96, respectively, and to the air conditioning element 130, which is shown in phantom in FIGS. 5 and 6, at the other end. Specifically, the mounting arms 90 and 92 are mounted to the earth plane 132 at pivot pins 98 and 100, respectively, and to the ionization grid 136 at pivot pins 102 and 104, respectively. When the air conditioning element 130 comprises only one component, the pivot pins 102 and 104 are not required. Each of the first and second mounting arms 90 and 92 further comprise an inwardly directed flange 106 and 108, respectively, at the end adjacent the pivot pins 94 and 96.

Because of the orientation of the pivot pins 98 and 100 relative to that of the pivot pins 102 and 104, the earth plane 132 and the ionization grid 136 are secured in parallel alignment. However, since the first and second mounting arms 90 and 92 are coupled with the earth plane 132 and the ionization grid 136 by means of pivot pins, the first and second mounting arms 90 and 92 can pivot relative to the air conditioning element 130. As the mounting arms 90 and 92 rotate, the earth plane 132 and the ionization grid 136 maintain a parallel orientation while the spacing therebetween decreases or increases, depending on the rotation direction.

The series of mechanical linkages 82 further comprises an actuating arm 110 with a lengthwise slot 112 and a finger tab 114. The actuating arm 110 is substantially colinear with and movable relative to the guide rail 80, and the pivot pin 96 of the second mounting arm 92 resides in the slot 112. When the expansion mechanism 60 is in the expanded condition, as shown in FIG. 5, the finger tab 114 is coincident with an end of the guide rail 80. As the finger tab 114 is pulled away from the end of the guide rail 80, the actuating arm 10 moves to the collapsed condition shown in FIG. 6, and the slot 112 is displaced relative to the pivot pin 96.

A linkage arm 116 links the first mounting arm 90 with the actuating arm 110. Specifically, the linkage arm 116 is pivotally coupled with the first mounting arm 90 at the pivot pin 98 and with the end of the actuating arm 110 at a pivot pin 118. Further, the pivot pin 118 resides in the groove 84 of the guide rail 80 such that the pivot pin 118 can slide along the groove 84 as the expansion mechanism 60 moves between the expanded and collapsed conditions. As a result of the pivot pins 98 and 118, the first mounting arm 90, the linkage arm 116, and the actuating arm 110 are interconnected. Movement of one of the arms 90, 116, or 110 results in simultaneous movement of the other two arms. Most notably, the reciprocation of the actuating arm causes the first mounting arm to pivot. The second mounting arm 92 is likewise pivoted because the first and second mounting arms are coupled in movement by the air conditioning element 130. Thus, the reciprocation of the actuating arm 110 moves the air conditioning element 130 between the collapsed and extended positions.

When the expansion mechanism 60 is assembled to the peripheral frame 62, the actuating arm 110 is disposed inside the corresponding hollow bar 64, as seen in FIGS. 3 and 4, while the guide rail 80 and the other components of the mechanical linkages 82 are disposed adjacent to the corresponding hollow bar 64 such that the filter guides 89 are directed towards the recess 50. The pivot pins 94 and 96 are received through the corresponding holes 70 of the hollow bar 64, and the pivot pin 118 resides in the slot 68 in the hollow bar 64.

To move the expandable air cleaner frame 30 from the expanded condition in FIGS. 2, 3, and 5, to the collapsed condition in FIGS. 4 and 6, the actuating arms 110 are pulled away from the peripheral frame 62 by means of the finger tabs 114. As the actuating arms 110 move, the slots 112 are displaced relative to the pivot pins 96 of the second mounting arms 92, and the pivot pins 118 of the actuating arms 110 travel through the grooves 84 on the guide rails 80. In turn, the pivot pins 118 draw the linkage arms 116 in the same direction as the actuating arms 110, and the linkage arms 116 simultaneously pivot and pull the pivot pins 98 towards the guide rails 80. The motion of the linkage arms 116 and the pivot pins 98 causes the first mounting arms 90 to pivot counterclockwise, relative to the view in FIG. 5, about pivot pin 94 and towards the guide rails 80. Rotation of the first mounting arms 90 forces the earth plane 132 and the ionization grid 136 to move in the same direction as the actuating arms 110. As a result, the earth plane 132 and the ionization grid 136 compel the second mounting arms 92 to rotate about the pivot pins 96 in a counterclockwise direction, relative to the view in FIG. 5, towards the guide rails 80. During rotation of the first and second mounting arms 90 and 92, the flanges 106 and 108 move towards the nearby indents 88 in the guide rails 80 and the pivot pins 102, 98, and 104 move towards the corresponding notches 86 in the guide rails 80. Furthermore, the pivot pins 98 and 100 move towards the notches 72 of the hollow bars 64.

As discussed above, the earth plane 132 and the ionization grid 136 maintain a parallel orientation as the first and second mounting arms 90 and 92 rotate towards the guide rails 80. Further, the earth plane 132 and the ionization grid 136 become offset relative to each other while the spacing therebetween decreases. In particular, the ionization grid 136 shifts towards the peripheral frame 62, and the earth plane 132 moves towards the ionization grid 136.

The expandable air cleaner frame 30 achieves the collapsed condition in FIG. 6 when the actuating arms 110 are fully extended, the linkage arms 116 are substantially parallel with the guide rails 80, and the first and second mounting arms 90 and 92 are completely rotated and substantially colinear with the guide rails 80. The flanges 106 and 108 of the fully rotated first and second mounting arms 90 and 92, respectively, are received within the nearby indents 88 in the guide rails 80, the pivot pins 102, 98, and 104 are positioned in the corresponding notches 86 in the guide rails 80, and the pivot pins 98 and 100 are disposed in the notches 72 of the hollow bars 64.

In the collapsed condition, the air conditioning element 130 is shifted towards the peripheral frame 62. In the embodiment shown in FIG. 3, the earth plane 132 and the ionization grid 136 are directly adjacent to each other and the ionization grid 136 is directly adjacent to the guide rails 80. The air conditioning element 130 can reside completely within the recess 50, as illustrated in FIG. 3, or in another location, such as partially within the recess 50 or adjacent the recess 50. When collapsed, the collective thickness of the expandable air cleaner frame 30, which, in general, is the thickness of the peripheral frame 62 plus the thickness of any portion of the expansion mechanism 60 and the air conditioning element carrier that extends beyond the peripheral frame 62, is equal to a predetermined expandable air cleaner frame thickness that is less than the width of the opening 22. Because the collective thickness is less than the width of the opening 22 in the return duct 12, the collapsed expandable air cleaner frame 30 can be received within the opening 22.

To move the expandable air cleaner frame 30 from the collapsed condition to the expanded condition, the actuating arms 110 are pushed towards the peripheral frame 62, by means of the finger tabs 114. As a result, the series of mechanical linkages 82 moves and rotates in a manner opposite of that described above for moving the expandable air cleaner frame 30 from the expanded condition to the collapsed condition. In brief, the actuating arms 110 urge the linkage arms 116 towards the first mounting arms 90 thereby forcing the first mounting arms 90 to rotate clockwise, relative to the view in FIG. 5, about the pivot pins 94. As the first mounting arms 90 rotate, the air conditioner element 130 shifts away from the recess 50. Movement of the earth plane 132 and the ionization grid 136 forces the second mounting arms 92 to rotate clockwise, relative to the view in FIG. 5, about the pivot points 96. The first and second mounting arms 90 and 92 rotate until they are substantially perpendicular relative to the guide rails 80. In this condition, the earth plane 132 and the ionization grid 136 are spaced from each other and from the peripheral frame, as shown in FIG. 5, and the collective thickness is greater than the width of the opening 22.

When the expandable air cleaner frame 30 is in the expanded condition, the air conditioning element 130 is spaced from the recess 50, and the collector 150, such as a conventional or standard panel filter or an electrostatically charged filter, having a width less than that of the elongated aperture 46 can be positioned therein. The collector 150 is inserted into the expandable frame 30 through the elongated aperture 46 in the peripheral frame 62, and the filter guides 89 on the guide rails 80 direct the collector 150 into position. The spring tabs 76 on the peripheral frame 62 secure the fully inserted collector 150 within the expandable air cleaner frame 30. The flanges 106 and 108 support the collector 150 so that it is not inadvertently forced downstream. An end cap 140, shown in FIG. 2, can be positioned over the aperture 46 and mounted to the actuating arms 110 to further secure the collector 150 in place. The collector 150 can be removed by simply pulling it out of the recess 50 through the aperture 46. If there is more than one collector, a last inserted collector can be removed by simply pulling it through the aperture 46,and removal of a first inserted collector can optionally be facilitated by the use of finger loops or tabs (not shown).

Alternatively, the collector 150 can be positioned within the peripheral frame 62 when the expandable air cleaner frame 30 is in the collapsed condition, depending on the orientation of the collapsed air conditioning element 130 relative to the recess 50 or the size of the collector 150. If the air conditioning element 130 is adjacent to the recess 50 or if the thickness of the collector 150 is small enough to provide sufficient clearance for the air conditioning element 130 within the recess 50, then the collector 150 can be received within the peripheral frame 62 while the expandable air cleaner frame 30 is collapsed. In another scenario, a compressible collector can be inserted into the peripheral frame 62 while the expandable air cleaner frame 30 is expanded, and the expandable air cleaner frame 30 can thereafter be moved to the collapsed condition even if at least a portion of the air conditioning element 130 resides within the recess 50. As the air conditioning element 130 enters the recess 50, it compresses the collector 150 to accommodate the portion of the air conditioning element 130 that resides within the recess 50.

The expandable air cleaner frame 30, the air conditioning element 130, and the collector 150 form an air cleaner assembly having an effective thickness. The effective thickness is defined as the thickness of the expandable air cleaner frame 30 with the collector 150 therein plus the thickness of any portion of the air conditioning element 130 that extends beyond the expandable air cleaner frame 30. When in the collapsed condition, the effective thickness of the air cleaner assembly is less than the width of the opening 22, and the air cleaner assembly can be inserted through the opening 22. However, when moved to the expanded condition, the effective thickness of the air cleaner assembly increases to greater than the width of the opening 22.

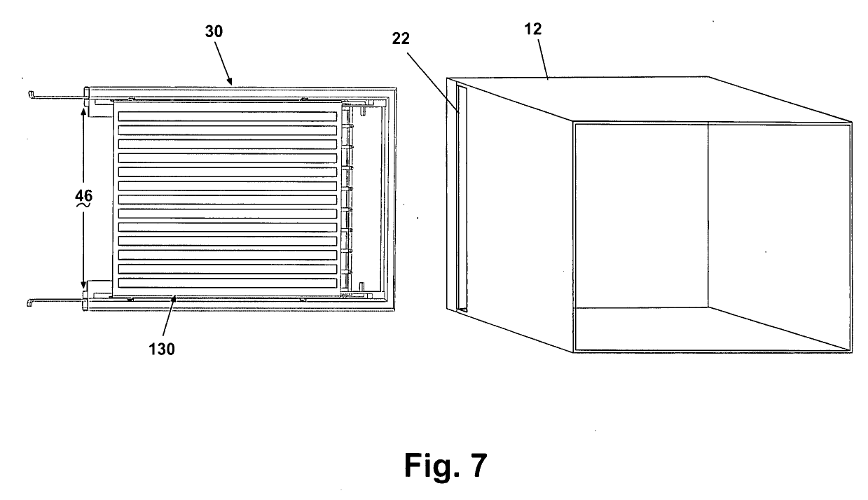

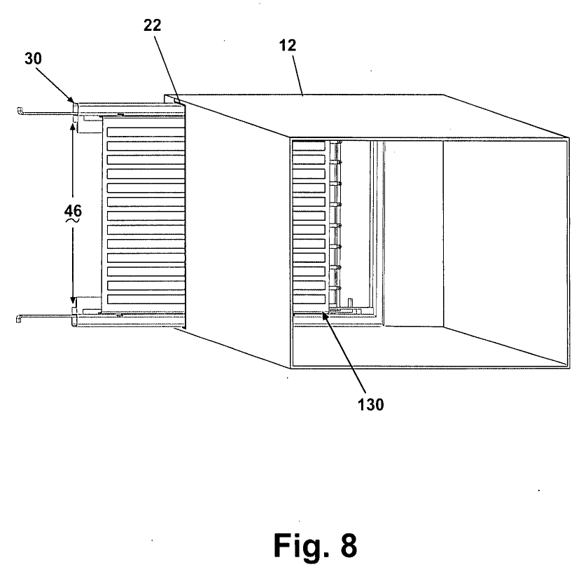

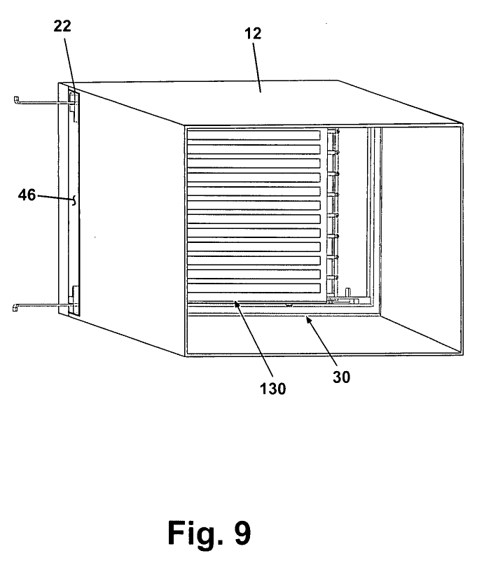

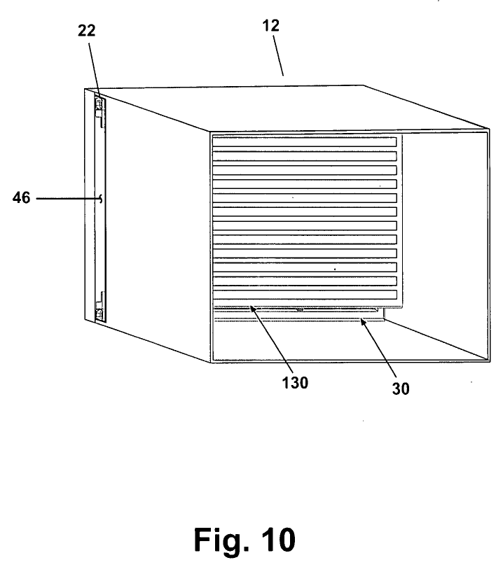

The operation of this embodiment of the air cleaner 24 will now be described with reference to FIGS. 7-12. As illustrated in FIG. 7, a user aligns the expandable air cleaner frame 30, which is in the collapsed condition and has a collective thickness less than the width of the opening 22, with the opening 22 in the return duct 12. Next, the user inserts the expandable air cleaner frame 30 through the opening 22, as shown in FIG. 8, and slides the expandable air cleaner frame 30 into the return duct 12 until it is completely received therein. In this state, the aperture 46 of the peripheral frame 62 is substantially coincident with the opening 22, as depicted in FIG. 9. Once the expandable air cleaner frame 30 is positioned within the return duct 12, the user pushes on the finger tabs 114 to displace the actuating arms 110 and thereby move the expandable air cleaner frame 30 from the collapsed condition to the expanded position as described above. It is apparent in FIG. 10 that when the expandable air cleaner frame 30 is in the expanded condition, the earth plane 132 and the ionization grid 136 project into the airflow passageway in the return duct 12 and away from the opening 22.

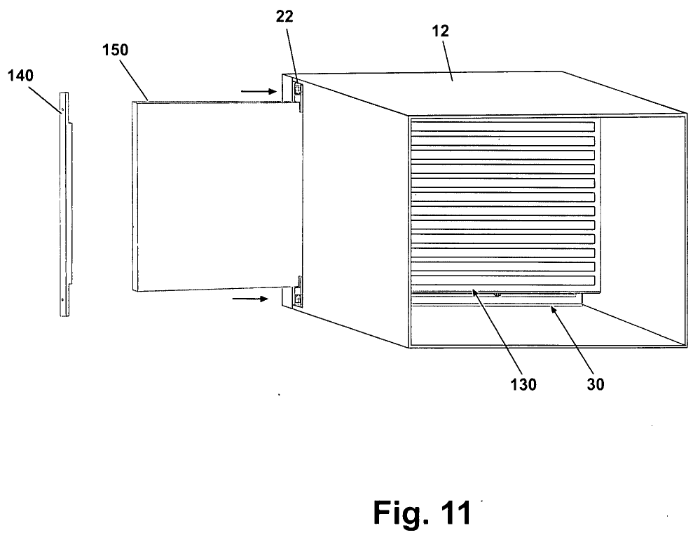

The user can optionally insert the collector 150 by introducing the collector 150 into the opening 22 of the return duct 12 and, therefore, the aperture 46 of the peripheral frame 62, as depicted in FIG. 11. The filter guides 89 and the spring tabs 76 direct and secure the collector 150 as explained above. After the collector 150 is completely disposed within the expandable air cleaner frame 30, the end cap 140 is positioned over the aperture 46 and mounted to the actuating arms 110, as illustrated in FIG. 12. Alternatively, the step of inserting the collector 150 can occur during any portion of the operation process, such as while the expandable air cleaner frame 30 is in the collapsed condition, as described earlier.

As air flows through the return duct 12, as indicated by the arrow in FIG. 12, the expandable air cleaner frame 30, equipped with the air conditioning element 130 and the collector 150, efficiently removes dust and other particulate matter. When the air conditioning element 130 comprises the earth plane 132 and the ionization grid 136, the earth plane 132 directs air through the cutouts 134 and toward the ionization grid 136, which releases ions that interact with the dust and particulate matter to form ionized particles. The air and ionized particles continue to flow through the collector 150, where dust, the ionized particles, and other particulate matter are captured. Purified air, which undergoes only a relatively low pressure drop, then exits the expandable air cleaner frame 30, flows through the central unit 14, and is distributed throughout the home. If the collector 150 requires replacement or cleaning while the expandable air cleaner frame 30 is disposed in the duct 12, the end cap 140 is removed, the dirty collector 150 is easily pulled out of the expandable air cleaner frame 30, and a cleaned or new collector 150 is inserted therein as described above.

To remove the expandable air cleaner frame 30 from the return duct 12 to, for example, clean the air conditioning element 130, the end cap 140 is removed, the collector 150 is drawn through the opening 22, and the finger tabs 114 are pulled to move the expandable air cleaner frame 30 from the expanded condition to the collapsed condition. Once the expandable air cleaner frame 30 is collapsed, it is pulled through the opening 22 until it is completely removed from the return duct 12. Alternatively, the step of removing the collector 150 can occur during any portion of the removal process, such as while the expandable air cleaner frame 30 is in the collapsed condition, as described earlier.

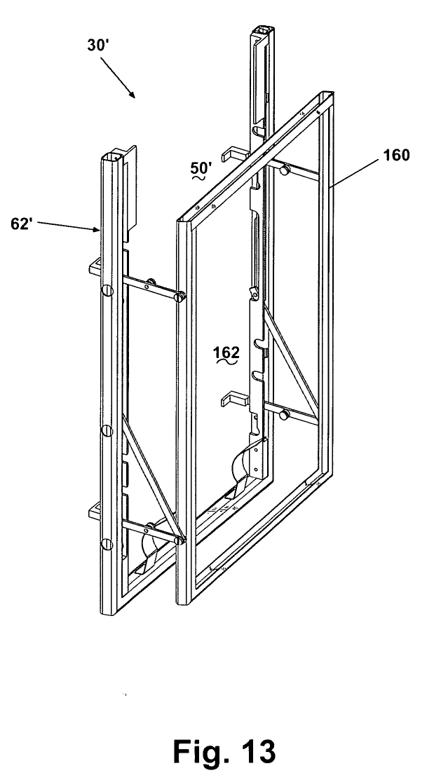

A second embodiment of an expandable air cleaner frame 30′ according to the invention is illustrated in FIG. 13, where like elements are identified with like reference numerals bearing a prime (′) symbol. The second embodiment is identical to the first embodiment, except that the second comprises an auxiliary peripheral frame 160 as the air conditioning element carrier. The auxiliary peripheral frame 160 can be of any desired structure. As illustrated, the auxiliary peripheral frame 160 is formed by U-shaped channel members, which collectively form an open-sided recess 162 in which a collector or air conditioner element can be received. Any suitable collector or air conditioner element, such as a reusable or replaceable filter, a conventional panel filter, a pleated filter, an electrostatically charged pleated filter, and the like can be inserted into the open-sided recess. The operation of the second embodiment of the invention is similar to that of the first. The collector is preferably inserted into the auxiliary peripheral frame 160 prior to inserting the expandable air cleaner frame 30′ into the opening.

The benefit of the second embodiment over the first embodiment is that the auxiliary peripheral frame 160 functions as the carrier and is not integrated with the air conditioning element. Thus, the user is provided with the convenience of easily selecting or changing the type of air collector or air conditioning element used. The user has the ability to mix and match collectors and air conditioning elements as desired. The second embodiment can also include multiple auxiliary peripheral frames 160 if desired.

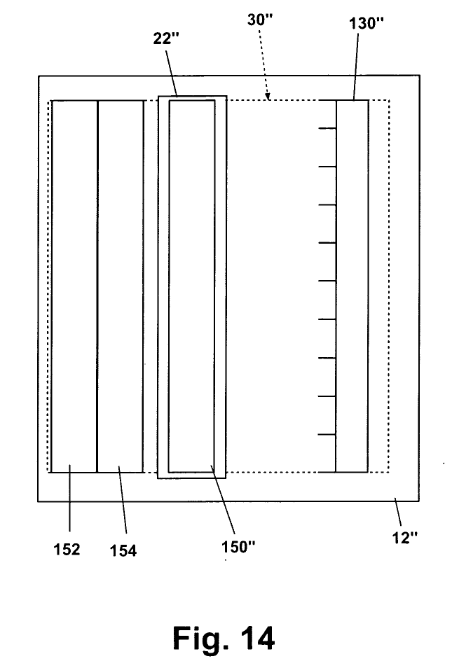

A third embodiment of an expandable air cleaner frame 30″ according to the invention is illustrated schematically in FIG. 14, where like elements are identified with like reference numerals bearing a double prime (″) symbol. The third embodiment is an expandable air cleaner frame 30″ and an air conditioning element 130″ identical to the first embodiment and further includes a loading mechanism for loading or shifting individual air conditioner elements or collectors, in singular or modular form, within the duct 12″. One example of a simple loading mechanism is the spring tabs 76 of the first embodiment. The spring tabs 76 shift the individual collectors or collector modules downstream. The loading mechanism can be any device to load and shift air conditioner elements or collectors within the duct; it can comprise mechanical, electrical, pneumatic, hydraulic, or any other suitable loading and shifting means. As a result, several types of air conditioner elements or collectors can be installed through the expandable air cleaner frame 30″, and a user can create customized air filtration to accommodate specific needs.

In operation, the expandable air cleaner frame 30″ is inserted into a return duct 12″ and expanded therein as described for the first embodiment. Once the expandable air cleaner frame 30″ is in the expanded condition, the user inserts a first collector, for example an odor elimination module 152, through the furnace opening 22″ and into the expandable air cleaner frame 30″. Next, the collector loading mechanism shifts the odor elimination module 152 within the duct 12″ so that a second collector, for example an electrostatically charged pleated filter 154, can be inserted through the furnace opening 22″ and into the expandable air cleaner frame 30″. The inserting and shifting process continues until the last collector, for example a conventional panel filter 150″, is inserted through the furnace opening 22″ and into the expandable air cleaner frame 30″.

The invention can utilize various types of air conditioning elements 130 and collectors 150 that require a power source for operation. Although the power source is not shown in any of the illustrated embodiments, one can easily be coupled with any of the expandable air cleaner frames, air conditioning elements, and collectors to provide power thereto.

The expandable air cleaner frame according to the invention is an affordable device for incorporating advanced filter systems into conventional furnace ducts. Because the expandable air cleaner frame can be introduced and removed through a typical opening in a furnace, air conditioning elements, such as in electrostatic precipitators, ionizers, and the like, can be employed without requiring expensive and labor intensive professional installation. Additionally, a plurality of collectors or collector modules, such as conventional panel filters, pleated filters, electrostatically charged filters, charged plates, odor elimination modules, ultraviolet light modules, and the like, can be used to complement the filtering capabilities of the air conditioning elements and to create customized air filtering that does not significantly reduce the pressure of the airflow therethrough.

While the invention has been specifically described in connection with certain specific embodiments thereof, it is to be understood that this is by way of illustration and not of limitation, and the scope of the appended claims should be construed as broadly as the prior art will permit.

1. An air cleaner for use in an air conditioning system comprising an air duct defining an airflow passage, with the air duct defining an airflow path and having a standard filter opening of a predetermined size in which a standard filter can be inserted into the airflow passage to filter the air passing through the air duct, the air cleaner comprising:
a collector;
an air conditioning element; and
an expandable air cleaner frame carrying both the collector and the air conditioning element to form an air cleaner assembly having an effective thickness, the expandable air cleaner frame being operable between a collapsed condition, wherein the effective thickness of the air cleaner assembly is such that the air cleaner assembly can be received within the standard filter opening, and an expanded condition, wherein the effective thickness of the air cleaner assembly is greater than the standard filter opening.

2. The air cleaner according to claim 1 wherein when the expandable air cleaner frame is moved from the collapsed to the expanded condition, at least one of the collector and the air conditioning elements extended into the airflow passage along the airflow path to thereby increase the effective thickness of the air cleaner assembly.

3. The air cleaner according to claim 1 wherein the effective thickness of the air cleaner assembly is less than 1 inch when in the collapsed condition.

4. The air cleaner according to claim 1 wherein the collector comprises a layer of random fibers.

5. The air cleaner according to claim 4 wherein the random fibers are charged.

6. The air cleaner according to claim 4 wherein the collector is a low flow reducing filter.

7. The air cleaner according to claim 1 wherein the air conditioning element is a charged particle air cleaner.

8. The air cleaner according to claim 7 wherein the air conditioning element comprises an ionizing plate for generating ions to create ionized particles in the air stream.

9. The air cleaner according to claim 8 wherein the collector comprises one or more charged plates for attracting the ionized particles.

10. The air cleaner according to claim 9 wherein the air conditioning element further comprises a ground plate for directing the flow of ions from the ionizing plate.

11. The air cleaner according to claim 7 wherein the charged particle air cleaner is an electrostatic precipitator.

12. The air cleaner according to claim 7 wherein the charged particle air cleaner is an ionizer.

13. The air cleaner according to claim 1 wherein the air conditioning collector is a HEPA filter.

14. The air cleaner according to claim 1 wherein the expandable air cleaner frame comprises an expansion mechanism for moving the expandable air cleaner frame between the collapsed and expanded conditions.

15. The air cleaner according to claim 14 wherein the expansion mechanism is operable externally of the duct when the air cleaner is inserted into the duct to permit the movement of the expandable air cleaner frame from the collapsed to the expanded condition after the air cleaner is inserted within the duct.

16. The air cleaner according to claim 14 wherein the expansion mechanism displaces at least one of the collector and the air conditioning element along the airflow path to thereby change the effective thickness of the air cleaner assembly.

17. The air cleaner according to claim 16 wherein the expandable air cleaner frame comprises a peripheral frame and a carrier, with one of the collector and air conditioning element mounted to the peripheral frame and the other of the collector and air conditioning element carried by the carrier, and the expansion mechanism connecting the carrier to the peripheral frame such that the expansion mechanism moves the carrier relative to the peripheral frame to move the expandable air cleaner frame between the collapsed and expanded conditions.

18. The air cleaner according to claim 17 wherein the carrier is integrally formed with the other of the collector and air conditioning element.

19. The air cleaner according to claim 17 wherein the expansion mechanism comprises at least one series of mechanical linkages for moving the expandable air cleaner frame between the collapsed and expanded conditions.

20. The air cleaner according to claim 19 wherein the at least one series of mechanical linkages is coupled with the peripheral frame and with the carrier so that displacement of the series of mechanical linkages moves the carrier relative to the expandable air cleaner frame.

21. The air cleaner according to claim 20 wherein the expansion mechanism further comprises an actuating arm for displacing the series of mechanical linkages.

22. The air cleaner according to claim 21 wherein the expansion mechanism further comprises a guide rail for directing the displacement of the series of mechanical linkages and the actuating arm.

23. The air cleaner according to claim 1 wherein the expandable air cleaner frame comprises a peripheral frame with a recess sized to receive a standard filter.

24. An expandable air cleaner frame for an air conditioning system having a duct with an opening having a predetermined size and defining an airflow path, the expandable air cleaner frame comprising:
a peripheral frame sized to be slidably received within the opening in the duct, and the peripheral frame forming a filter element recess sized to receive a filter element; and
a carrier for carrying a filter element and moveably mounted to the peripheral frame for movement between a collapsed condition, where the collective thickness of the peripheral frame and the carrier is such that they can be received within the opening in the duct, and an expanded condition, wherein the collective thickness of the peripheral frame and the carrier is greater than the opening in the duct;
wherein the expandable air cleaner frame can be inserted into the duct opening in the collapsed condition and then moved to the expanded condition to permit multiple filter elements to be inserted into the duct through the duct opening.

25. The expandable air cleaner frame according to claim 24 wherein at least a portion of the carrier is received within the filter element recess when the expandable air cleaner frame is in the collapsed condition.

26. The expandable air cleaner frame according to claim 24 wherein the peripheral frame comprises an aperture through which a filter element can be slidably inserted into the peripheral frame.

27. The expandable air cleaner frame according to claim 24 wherein during movement of the carrier from the collapsed to the expanded condition, the carrier moves into the duct in a direction along the airflow path through the duct.

28. The expandable air cleaner frame according to claim 24 and further comprising an expansion mechanism for moving the carrier between the collapsed and expanded conditions.

29. The expandable air cleaner frame according to claim 28 wherein the expansion mechanism is operable externally of the duct when the expandable air cleaner frame is inserted into the duct to permit the movement of the expandable air cleaner frame from the collapsed to the expanded condition after the expandable air cleaner frame is inserted within the duct.

30. The expandable air cleaner frame according to claim 28 wherein the expansion mechanism moves the carrier relative to the peripheral frame to thereby change the collective thickness of the peripheral frame and the carrier.

31. The expandable air cleaner frame according to claim 28 wherein the expansion mechanism comprises at least one series of mechanical linkages for moving the expandable air cleaner frame between the collapsed and expanded conditions.

32. The expandable air cleaner frame according to claim 31 wherein the at least one series of mechanical linkages is coupled with the peripheral frame and with the carrier so that displacement of the series of mechanical linkages moves the carrier relative to the peripheral frame.

33. The expandable air cleaner frame according to claim 32 wherein the expansion mechanism further comprises an actuating arm for displacing the series of mechanical linkages.

34. The expandable air cleaner frame according to claim 33 wherein the expansion mechanism further comprises a guide rail for directing the displacement of the series of mechanical linkages and the actuating arm.

35. An air conditioning system comprising:
an air duct;
an airflow passage through the air duct;
a standard filter opening of a predetermined size in the air duct and in which a standard filter can be inserted into the airflow passage to filter the air passing through the air duct; and
an air cleaner;
wherein the air cleaner comprises:
a collector;
an air conditioning element; and
an expandable air cleaner frame carrying both the collector and the air conditioning element to form an air cleaner assembly having an effective thickness, the expandable frame being operable between a collapsed condition, wherein the effective thickness of the air cleaner assembly is such that the air cleaner assembly can be received within the standard filter opening, and an expanded condition, wherein the effective thickness of the air cleaner assembly is greater than the standard filter opening.

36. The furnace according to claim 35 wherein when the expandable air cleaner frame is moved from the collapsed to the expanded condition, at least one of the collector and the air conditioning element is extended into the airflow passage along the airflow path to thereby increase the effective thickness of the air cleaner assembly.

37. The air conditioning system according to claim 35 wherein the effective thickness of the air cleaner assembly is less than 1 inch when in the collapsed condition.

38. The air conditioning system according to claim 35 wherein the collector comprises a layer of random fibers.

39. The air conditioning system according to claim 38 wherein the random fibers are charged.

40. The air conditioning system according to claim 38 wherein the collector is a low flow reducing filter.

41. The air conditioning system according to claim 35 wherein the air conditioning element is a charged particle air cleaner.

42. The air conditioning system according to claim 41 wherein the air conditioning element comprises an ionizing plate for generating ions to create ionized particles in the air stream.

43. The air conditioning system according to claim 42 wherein the collector comprises one or more charged plates for attracting the ionized particles.

44. The air conditioning system according to claim 43 wherein the air conditioning element further comprises a ground plate for directing the flow of ions from the ionizing plate.

45. The air conditioning system according to claim 41 wherein the charged particle air cleaner is an electrostatic precipitator.

46. The air conditioning system according to claim 41 wherein the charged particle air cleaner is an ionizer.

47. The air conditioning system according to claim 35 wherein the air conditioning collector is a HEPA filter.

48. The air conditioning system according to claim 35 wherein the expandable air cleaner frame comprises an expansion mechanism for moving the expandable air cleaner frame between the collapsed and expanded conditions.

49. The air conditioning system according to claim 48 wherein the expansion mechanism is operable externally of the duct when the air cleaner assembly is inserted into the duct to permit the movement of the expandable air cleaner frame from the collapsed to the expanded condition after the air cleaner assembly is inserted within the duct.

50. The air conditioning system according to claim 48 wherein the expansion mechanism displaces one of the collector and the air conditioning element along the airflow path relative to the expandable air cleaner frame to thereby change the effective thickness of the air cleaner assembly.

51. The air conditioning system according to claim 50 wherein the expandable air cleaner frame comprises a peripheral frame and a carrier, with one of the collector and air conditioning element mounted to the peripheral frame and the other of the collector and air conditioning element carried by the carrier, and the expansion mechanism connecting the carrier to the peripheral frame such that the expansion mechanism moves the carrier relative to the peripheral frame to move the expandable air cleaner frame between the collapsed and expanded conditions.

52. The air conditioning system according to claim 51 wherein the carrier is integrally formed with the other of the collector and air conditioning element.

53. The air conditioning system according to claim 51 wherein the expansion mechanism comprises at least one series of mechanical linkages for moving the expandable air cleaner frame between the collapsed and expanded conditions.

54. The air conditioning system according to claim 53 wherein the at least one series of mechanical linkages is coupled with the peripheral frame and with the carrier so that displacement of the series of mechanical linkages moves the carrier relative to the expandable air cleaner frame.

55. The air conditioning system according to claim 54 wherein the expansion mechanism further comprises an actuating arm for displacing the series of mechanical linkages.

56. The air conditioning system according to claim 55 wherein the expansion mechanism further comprises a guide rail for directing the displacement of the series of mechanical linkages and the actuating arm.

57. The air conditioning system according to claim 35 wherein the expandable air cleaner frame comprises a peripheral frame with a recess sized to receive a standard filter.
